(19) United States
(12) Patent Application Publication
(10) Pub. No.: US 2008/0268412 A1
(43) Pub. Date: Oct. 30, 2008

(54) Method for Improving Patient Chronic Disease Education

(75) Inventors: Kathryn Mulcahy, Bradenton, FL (US); Melinda Maryniuk, Brookline, MA (US); Malinda Peeples, Baltimore, MD (US); Mark Peyrot, Baltimore, MD (US); Donna Tomky, Albuquerque, NM (US); Todd Weaver, Stillwater, MN (US); Peggy Yarborough, Holly Springs, NC (US)

Correspondence Address: BARNES & THORNBURG LLP, P.O. BOX 2786, CHICAGO, IL, 60690-2786, US

(73) Assignee: AMERICAN ASSOCIATION OF DIABETES EDUCATORS, Chicago, IL (US)

(21) Appl. No.: 11/574,309

(22) PCT Filed: Aug. 30, 2005
(86) PCT No.: PCT/US05/30917

§ 371 Date: Feb. 20, 2008

Related U.S. Application Data
(60) Provisional application No. 60/605,818, filed on Aug. 31, 2004.

(51) Int. Cl. G09B 23/28

(52) U.S. Cl. 434/262

(57) ABSTRACT

A method to determine, monitor, evaluate, and improve the effectiveness of self-management education for patients with a chronic disease. The present disclosure discloses that the effectiveness of a patient self-management education program can be determined and improved by evaluating specific standardized patient outcomes at standardized intervals, in particular by evaluating behavior changes in the patient receiving the education.

### BACKGROUND

The present disclosure relates to education of medical patients. More particularly, this disclosure relates to a system and method for determining, monitoring, and improving the effectiveness of patient education, especially education of persons having chronic disease.

Persons having certain chronic diseases such as diabetes mellitus or chronic heart disease, particularly those persons recently diagnosed with such diseases, require not only medical treatment and periodic clinical monitoring to minimize the adverse effects of their disease, but also education to enable them to manage their disease outside of the healthcare setting. Education is needed for effective care of such patients because they often must make lifestyle changes, learn new behaviors and skills, and monitor their own health parameters at frequent intervals. Medical educators strive to provide these patients with appropriate knowledge and skills, help them identify barriers to disease control, and facilitate problem solving and coping skills to enable them to achieve effective self-care behavior.

Standards for medical educators have been created and evolved which quantify the processes and structure of educational programs, including, for example, an advisory process, annual review of program objectives, and patient-focused behavioral objectives. Despite this emphasis on outcomes and program evaluation, however, specific indicators for education outcomes have not been defined. Without such specificity, each educator uses his or her own discretion and experience to determine what outcomes of patient self-management education to measure, how to measure them, and when to measure them. Educators currently have no objective way to know for sure if education is truly helping a particular patient or which educational techniques are most beneficial to most patients, nor can educators know if their programs are more or less effective than other programs. Payers are unable to judge the value of educational interventions. Additionally, the variation in measurements and frequencies has made defining and reporting specific characteristics of effective patient self-management education difficult if not impossible.

Although medical educators generally agree on the goals of education of patients with chronic disease, they currently vary greatly in their beliefs about the attributes of effective education and educational methods. Add to this the variety of patient conditions and situations, educator qualities and techniques, and outcome measurement frequencies, and educators are left with little guidance on how to proceed effectively.

It would therefore be desirable to develop a system and method whereby meaningful, measurable outcomes are identified, measured at standard intervals, and used to determine and improve the effectiveness of an educational program for an individual patient and the patient population overall.

Briefly, and in accordance with the foregoing, disclosed is a method that identifies measurable outcomes and provides a way to determine, monitor, evaluate, and improve the effectiveness of self-management education for patients with a chronic disease. The present disclosure discloses that the effectiveness of a patient self-management education program can be determined and improved by evaluating specific standardized patient outcomes at standardized intervals, in particular by evaluating behavior changes in the patient receiving the education.

### BRIEF DESCRIPTION OF THE DRAWINGS

The drawings are provided to illustrate some of the embodiments of the disclosure. It is envisioned that alternate configurations of the embodiments of the present disclosure maybe adopted without deviating from the disclosure as illustrated in these drawings.

FIG. 1 is a table of standards for outcomes measurement of self-management education in one embodiment of the present disclosure;

FIG. 2 is a table of self-care behaviors for one embodiment of the present disclosure;

FIG. 3 is a schematic diagram illustrating a continuum of outcomes categories employed in the present disclosure;

FIG. 4 is a table illustrating a use of aggregate population outcomes data for continuous quality improvement of a self-management education program according to one embodiment of the present disclosure;

FIG. 5 is a table illustrating an outline of the outcomes measurement process for one individual patient according to one embodiment of the present disclosure;

FIG. 6 is a flowchart showing a method or improving a self-management education program; and

FIG. 7 is a flowchart showing the method of FIG. 6 emphasizing how behavior change is measured.

### DETAILED DESCRIPTION

While the present disclosure may be susceptible to embodiments in different forms, there is shown in the drawings, and herein will be described in detail, embodiments with the understanding that the present description is to be considered an exemplification of the principles of the disclosure and is not intended to be exhaustive or to limit the disclosure to the details of construction and the arrangements of components set forth in the following description or illustrated in the drawings.

The effectiveness of an educational program for persons having a chronic disease that may benefit from self-management can be determined by measuring standard outcomes in standard ways at standard intervals and evaluating changes in the data. This system and method not only permits a determination of the effectiveness of the program for an individual patient, but also for participants of the program overall. This system and method also can identify areas for improvement for the program and provides for comparison between programs.

Self-management education of a patient with a chronic disease such as diabetes mellitus strives to improve the patient's overall health status by empowering the patient to: (a) acquire knowledge (what to do); (b) acquire skills (how to do it); (c) develop confidence and motivation to perform the appropriate self-care behaviors (want to do it); and (d) develop problem-solving and coping skills to overcome barriers to self-care behavior (can do it).

Disclosed is a method for determining and improving the effectiveness of a self-management education program for persons with diabetes mellitus. Persons skilled in the art will recognize that this method can be adapted for persons having other chronic diseases, in particular diseases that are treatable through a patient's or person's own behavior. The method could most easily be adapted for educational programs relating to chronic diseases commonly comorbid with diabetes, such as chronic heart disease or chronic kidney disease, but educational programs for other chronic diseases for which afflicted persons require or can benefit from self-management or behavior change could similarly be evaluated according to this method.

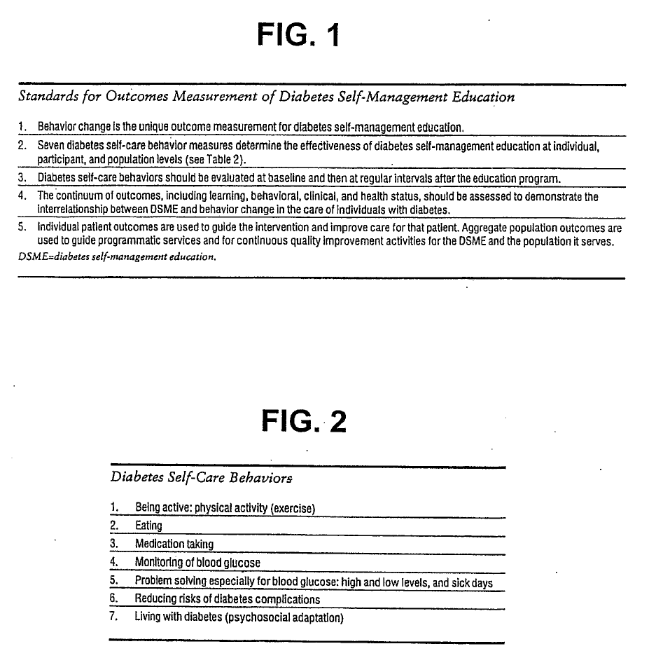

In the illustrated embodiment, five standards for outcomes measurement diabetes self-management education, are illustrated in FIG. 1. The first standard recognizes that behavior change is the desired outcome of an educational program for self-management of a chronic disease. The second standard requires the identification of specific behaviors for which change can determine the effectiveness of the self-management education program. The third standard suggests that the identified behaviors be evaluated at specified intervals. The fourth standard recognizes that a continuum of outcomes demonstrating an interrelationship between the education and the behavior change should be assessed. The fifth standard suggests that the outcomes measured be used to guide the care of the patient and be aggregated to guide and improve the educational program. Through adoption of a core measurement set, educators may be able to determine their effectiveness with individuals and populations, compare their performance with the established benchmarks, and establish the contribution of self-management education in the overall context of care of patients with chronic disease.

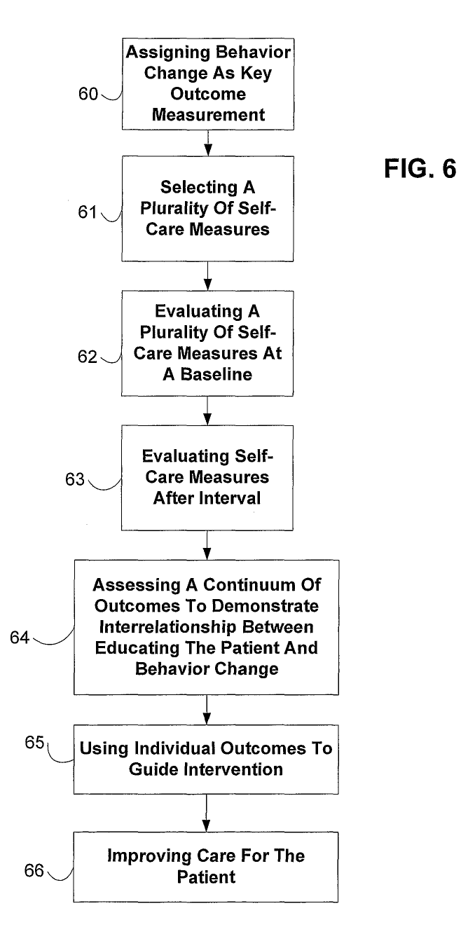

The general steps of one embodiment of the present method are shown in FIG. 6, with each step generally corresponding with a standard defined below. In a first step 60, behavior change is assigned as the key outcome measurement for the quality of the self-management education program. Next, a plurality of self-care measures are selected to be used, each intended to quantify the behavior change. The self-care measures may be the seven measures shown in FIG. 2, a subset of the seven measures, or other measures applicable to the subject chronic disease (step 61). In a next step (62), the self-care measures are evaluated at a baseline time, such as for example, immediately following educating the patient. Next, each selected self-care measure is evaluated after passage of a particular standardized interval, such as, for example, two to four weeks after the baseline, and then, for example, three to six months after the baseline (step 63). In a next step 64, the method involves assessing a continuum of outcomes to demonstrate interrelationship between educating the patient and behavior change. Finally, in steps 65-66, individual outcomes may be used to guide intervention and to improve patient care.

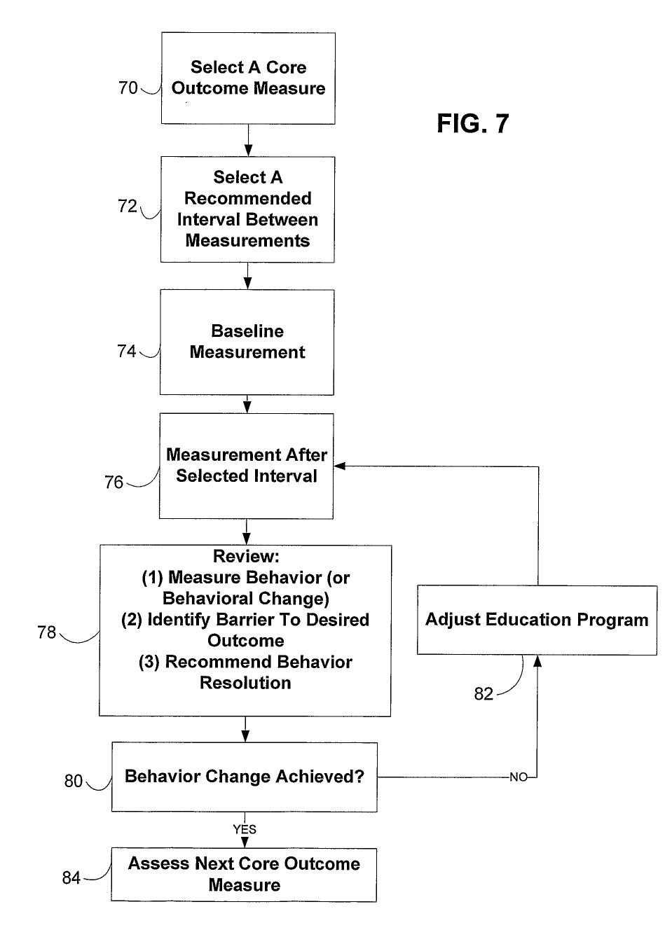

FIG. 7 shows one embodiment of the method of FIG. 6, further illustrating how behavior change is measured. A selected core outcome (step 70) is selected in connection with a standardized interval (step 72). A baseline measurement of the behavior is taken (step 74). The behavior is measured again at an end of the interval (step 76). In reviewing the selected measured behavior, the behavior is measured, any barriers to a desired outcome are identified, and a recommendation is made to the patient regarding how to overcome the barrier (step 78). If a behavior change is identified and achieved (step 80), a next core outcome may be considered (84) or else the education program may be adjusted (step 82). Although FIG. 7 shows one core measure being considered, more than one measure may be analyzed contemporaneously and still be within the scope of this disclosure.

The first standard of the present method is that behavior change is the desired outcome of self-management education and should be measured. To determine the effectiveness of a self-management educational program for a patient having a chronic disease according to this method, specific indicators of outcomes for measurement are defined, the frequency and time intervals of measuring these indicators for monitoring are determined, and then the data collected is used to male educational and clinical decisions. Outcomes measurement are desirably practical, feasible, informative, and consistent across educational programs. Outcomes measured generally may be achievable in a cost effective manner for both the individual and the population.

Individual outcomes measured according to a standard protocol can then be pooled, collated, and analyzed to determine and monitor the effectiveness of education of a particular individual as well as to monitor and improve the effectiveness of an educational program overall.

Many clinical measures that have been standardized and validated may be employed. Some behavioral, psychosocial, and attitudinal measures have also been validated and may be used. Generally, this means that such clinical measures have met scientific standards for reliability (the measure yields consistent results), validity (it measures what it purports to measure), and sensitivity (it is able to distinguish one state from another). Using preexisting measures that have been shown to have the desirable properties of reliability, validity, and sensitivity is recommended. Many such measures may exist for any particular outcome; however, using at least one of these measures may be more important than whether the single best measure is selected.

Many chronic diseases such as diabetes demand daily self-management, and people afflicted generally need to make lifestyle modifications to achieve successful control of the disease. These behavior changes often require training and ongoing support, which are central to self-management education. The fundamental goals of self-management education for persons with chronic disease are to prepare them to make informed decisions, engage in effective self-management of their disease, and implement self-care behaviors that allow them to maximize their physical and psychological well-being. Therefore, behavior change for self-management activities is directly affected by the education and is an indicator of overall program achievement.

The second standard recognizes that particular self-care behaviors can be measured and used to determine the effectiveness of self-management educational intervention. These behaviors can be measured at the individual, participant, and population levels. In the illustrated embodiment, seven specific self-care behaviors can be measured to determine the effectiveness of diabetes self-management education. For other chronic diseases, more or fewer behaviors may be appropriate to measure, and these behaviors may be the same or different than those behaviors identified here for diabetes.

In the illustrated embodiment, the seven selected core outcome measures are listed in FIG. 2. They are: (1) being active (exercise); (2) eating; (3) medication taking or taking medication; (4) monitoring blood glucose; (5) problem solving, especially for blood glucose; (6) reducing risks of diabetes complications; and (7) living with diabetes (psychosocial adaptation). These behaviors are explained in more detail below.

Other behaviors with similar concepts that are key to self-management of other chronic diseases will be evident to persons skilled in the art. For example, the first three core behavior outcome measure for diabetes would be similarly applicable to chronic heart disease with minimal modification. The fourth measure for chronic heart disease could be monitoring blood pressure or heart rate, rather than blood glucose. The fifth measure for chronic heart disease could be problem solving, especially for blood pressure or heart rate or rhythm. The sixth measure could be reducing risks of complications of chronic heart disease. The seventh measure could be living with chronic heart disease (psychosocial adaptation).

In the illustrated embodiment, educator assessment of the individual participant should include all seven behaviors, although a subset may used as well. Each behavior is important to the overall management of the chronic disease. One or more behaviors may become the focus, however, depending on participant choice, situation, idiosyncratic factors, readiness, success, level of disease, support resources, and barriers present. For each self-care behavior, the individual participating in self-management education will have specific knowledge, skills, and barriers. The educator should use the patient's self-care knowledge and skills to formulate patient-specific goals in collaboration with the patient. Treatment recommendations should be tailored to the particular individual and should include setting specific behavioral goals.

The educator may also help the participant to identify and assess the barriers to implementing self-care goals. The educator may then work with the participant to problem solve for resolution or to identify coping strategies to be used when the circumstances cannot be changed. Barriers may be cognitive (e.g., attitudes and beliefs), social (e.g., lack of support), financial (e.g., lack of resources), medical (e.g., regimen demands), physical (e.g., vision), or environmental (e.g., safety). Most factors that inhibit effective self-care can be regarded as barriers (e.g., lack of self-efficacy and no safe place to exercise). Although elimination of barriers may not be possible, one purpose of self-management education is to help participants find ways to overcome these roadblocks to effective self-care. Sometimes this may involve helping the patient identify different behavioral steps to achieve the goal or setting a different plan, such as doing indoor calisthenics rather than outdoor exercise such as walking. At other times, overcoming roadblocks may involve addressing factors that are associated with the behaviors, such as helping family members to be more supportive. Addressing barriers generally requires developing behavioral strategies, such as learning how to remember to test blood or take medications, how to overcome or avoid embarrassment, and how to avoid becoming demoralized by lapses in self-care or fluctuations in glycemic control or other measure of disease. As participants achieve initial goals, new goals may be set.

At the program level, one or more of the behavioral outcomes may be tracked for quality improvement and program evaluation efforts. Determining which behavior or behaviors to track and for how long may be based on administrative, operational, or regulatory purposes.

The third standard is that self-care behaviors should be evaluated at baseline and then at specified periodic intervals after the education program intervention. Periodic evaluation of self-care behaviors is important to determine and improve the effectiveness of an education program.

In one embodiment, for diabetes self-management education, measurement of the core behavior outcomes at baseline, and then after an interval, such as about two to four weeks later, and then about every three to six months, the behavior may be re-measured. Individual patients may be evaluated more often, but preferably be evaluated at these times as well to allow evaluation of the education program overall and comparison with other education programs. Other measurement periods suitable for application to education relating to other chronic diseases will be evident to persons skilled in the art. At a minimum, however, patient self-care behaviors should be measured at preintervention and postintervention times. Additional follow-up measurements are ideal and should be applied as appropriate to the practice setting.

Optimal measurement of behavior change may vary with the behavior, although evaluation intervals of three to six months may be appropriate in most practice settings. The interval of measurement for individual participants should be customized to their unique management plan and needs, recognizing that behavior change should preferably be practiced for at least about two weeks before reevaluation and should be differentiated from simple skill acquisition. The interval of measurement for program/aggregate data will usually be determined by internal and external organizational factors, such as operational demands of the parent organization, external accrediting and regulatory bodies, and quality improvement efforts.

The fourth standard according to present method is that the continuum of outcomes, including learning, behavior changes, clinical improvement, and health status, as well as immediate, intermediate, postintermediate, and long-term outcomes, should be assessed and will demonstrate the interrelationship between self-management education, behavior change, and health for individuals with chronic disease such as diabetes.

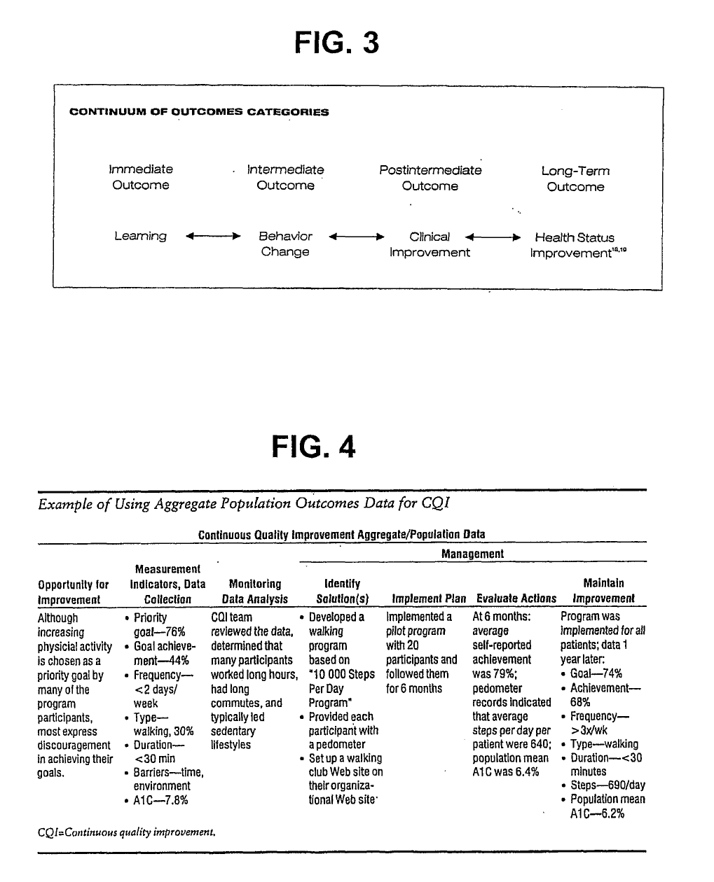

Multiple types and levels of outcomes for self-management education can and should be evaluated. Outcomes occur on a continuum over time. They are interconnected and influence and affect each other. FIG. 3 diagrams a continuum of outcomes categories and illustrates feedback loops. It should be appreciated that this diagram is for illustrative, purposes only; in practice, the categories blend into one another and each influences the others.

Immediate outcomes are those that can be measured at the time of an intervention. One type of immediate outcome is learning. Learning can be assessed by testing or direct observation after the self-management education intervention. An immediate objective of self-management education is to help participants develop self-care knowledge and skills to achieve self-care behavior and, in turn, enhance well-being. Self-care behaviors, along with appropriate therapeutic regimens, can enhance clinical status, reduce complications from the disease, and improve health status.

Intermediate and postintermediate outcomes develop over time, require more than a single measurement, are sensitive to change, and may show a statistical change. Behavior changes are a type of intermediate outcome and result from the educational participant's self management activities and the self-management process. Behavior changes can be measured through self-report.

Clinical improvement is a type of postintermediate outcome. Clinical improvement results from the interaction of self-management education, participant self-management, and clinical management, and can be measured with laboratory and procedural testing. Educators play an important role in monitoring a patient's clinical status and recommending or referring for appropriate clinical tests or interventions. Some examples of clinical measures for diabetes are glycosylated hemoglobin (A1C), blood pressure, body mass index, blood lipid levels, dilated eye examination, and foot examination.

Education may affect metabolic measures such as A1C, but so do other factors such as medical management and participant involvement in self-care. The educational process is not solely accountable for glycemic control, for example, which is influenced largely by factors that may not be within the educator's or participant's control. Multifaceted contributors, including physician counseling, participant knowledge and behavior, educators, and other health team interventions, prescribed therapies, and environmental factors may be outside any individual's control.

Long-term outcomes result from multiple variables over an extended time period. The educator should work collaboratively with the patient to maintain healthy self-management behaviors, which influence quality of life and improve health status. Quality of life is affected by duration of life, impairments, functional states, perceptions, and social opportunities and is health-related to the extent that disease, injury, treatment, or policy influence these concepts. The goal of care for chronic diseases such as diabetes or heart disease is improved overall health status. This improvement can result in quality-of-life and economic benefits for patients as well as for society as a whole.

Central to measuring quality improvement of an education program is having variables related to quality that are measured consistently, longitudinally, and at appropriate intervals. The variables measured may be measurable and accessible and promote changes in practice. In some instances, process accountability measures, such as whether an annual eye examination occurred, are also used for assessing quality even though they may not influence quality performance or clinical improvement.

The fifth standard is to use the patient outcomes to guide interventions and improve care for that patient and to aggregate outcomes for the patient population overall and use the aggregate data to guide educational program services and continuous quality improvement activities for the program and the population it serves. Setting targets for educational, behavioral, and clinical outcomes is a function of quality educational programs. One example of a method of using measured outcomes for quality improvement can be illustrated with the following steps: (1) identify the problem or opportunity; (2) collect the data needed to determine the measures or indicators; (3) analyze the data; (4) identify alternative solutions; (5) develop an implementation plan; (6) implement the plan; (7) evaluate the actions; and (8) maintain improvement.

In FIG. 4, a problem that has been identified is described in column 110, the identified measurement indicators and the data collected are listed in column 120, the results of data analysis are described in column 130, the solutions identified are described in column 140, the implementation plan is described in column 150, the results of several outcome measures at one evaluation point are specified in column 160, and in column 170 the results of implementation of the plan for a larger group of patients after a longer period of time are listed.

In the illustrated embodiment, the seven selected specific self-care behaviors that can be measured to determine the effectiveness of diabetes self-management education will now be explained in more detail. These core outcome measures are listed in FIG. 2.

The first of these seven core behaviors for the example of diabetes is being physically active. This behavior is also applicable to chronic heart disease and will be recognized by those skilled in the art as applicable to many other chronic diseases as well.

Increasing general activity through daily activities that increase overall mobility is considered beneficial to diabetics. Physical activity, or exercise, expends energy. Exercise may be aerobic or anaerobic. Aerobic exercise involves repetitive, submaximal contracting of major muscle groups used in activities such as swimming, cycling, walking, mowing the lawn, and vacuuming, and requires oxygen to sustain the muscular effort. Anaerobic exercise does not require sustained oxygen to meet the energy demands and generally does not induce the same health benefits as aerobic exercise. Studies have shown that properly designed resistance programs may improve cardiovascular function, glucose function, strength, and body composition. The intensity of exercise and the duration of the activity significantly influence its effect. Increasing general activity through daily activities that increase overall mobility is considered beneficial to diabetes management. Physical activity is important to health outcomes for diabetics because it improves glycemic control, reduces stress, improves the body mass index, enhances weight loss, and helps control lipids and blood pressure. Moderate physical activity and modest weight loss reduce the risk of developing type 2 diabetes.

One goal of diabetes self-management education is to increase the physical activity of an individual with diabetes. Even small changes may be beneficial. One goal is for the diabetic patient to engage in moderate aerobic activity for about 20 to about 30 minutes, about 3 to about 5 times per week. Individuals with diabetes should establish their own personal goals, even if those goals are not necessarily consistent with optimum physical activity that results in the greatest metabolic benefit.

The duration of physical activity or exercise depends on individual goals and objectives. For blood glucose control, in one regiment, exercise should last about 20 to about 40 minutes and be done about 3 to about 4 times weekly. For weight control, exercise should last, for example, approximately 45 to approximately 60 minutes and be done about 4 to about 5 times weekly. Duration and frequency of activity sessions often depend on age, time available for exercise, and level of fitness endurance. For persons starting an exercise program, the general recommendation is to aim for about three sessions per week, on nonconsecutive days, approximately 20 to approximately 30 minutes per session, achieving about 50% to about 55% of aerobic capacity or approximately 70% of age-adjusted maximal heart rate (generally considered 220 minus age in years). In one regiment, the duration of exercise needed to meet the required weekly energy expenditure is between about 20 and about 60 minutes per session. Studies have shown similar cardiovascular gains when physical activity is done for shorter durations of approximately 10 minutes at a time accumulated throughout the day, although about 30 minutes of continuous exercise seems to have a greater impact on weight loss. An educational intervention that teaches participants the knowledge and skill to incorporate physical activity into their daily lives may be included in a diabetes self-management education curriculum.

Standard data elements for outcomes/performance measurement may be measured initially, remeasured at a standardized interval, for example, about two to four weeks, and then measured again, for example, about every three to six months. These data elements include knowledge (exercise safety and relationship to food and medications), as well as current physical activity behavior, including type, duration, frequency, and intensity. The individual's goal for desired change and barriers to the potential degree of success the individual may experience may be identified. Also important is measuring the participant's knowledge of anticipatory behavior, such as appropriate pre-exercise food intake and adjusting self-monitoring of blood glucose frequency to the duration and intensity of activity planned. Data on this behavior can be collected through a self-report method, observation, or physical activity measurement instruments such as a pedometer.

The second self-care behavior for diabetes self-management is eating. Eating involves a complex set of behaviors. Decisions are made many times a day regarding what to eat, when to eat, and how much to eat. Many factors affect those decisions, including food availability, family eating patterns, habits, emotions, food preferences, blood glucose control, and knowledge regarding how food affects diabetes control and overall health. Skills involved with eating behavior for persons with diabetes can include carbohydrate and fat gram counting, label reading, and measuring foods for portion control.

Four diet behavior have been identified that may be relevant to eating: (1) adherence to meal plan; (2) appropriate treatment of hypoglycemia; (3) prompt response to hyperglycemia (more insulin and/or less food); and (4) consistent consumption of a prescribed evening snack, if appropriate. Following appropriate meal plans can result in a 1% to 2% decline in A1C, K; a 15 to 25 mg drop in LDL cholesterol; a decrease in blood pressure; and a 1 to 2 pound weight loss per week,

One goal of the educational intervention in nutrition is to assist and facilitate individual lifestyle and eating behavior changes that will lead to improved metabolic control, a reduced risk for complications, and improved health. Depending on an individual's usual eating style, new eating behaviors may or may not have to be learned as part of diabetes treatment and education. Each food plan may be uniquely designed in collaboration with the person with diabetes and be based on individual eating patterns, treatment objectives, or needs. Plans may focus on a particular goal or combination of goals, such as regulating carbohydrate intake, adjusting the timing or spacing of meals and snacks, reducing the saturated fat content, reducing overall calories, or increasing fiber intake.

Nutrition outcomes, therefore, may depend on individualized meal plan goals. To effectively individualize the meal plan, educational and behavioral goals may consider barriers or facilitators of environmental triggers, and emotional, cultural, and financial concerns.

Medical nutrition therapy is both a form of treatment and a component of a comprehensive self-management education program. Extensive field testing has demonstrated that when medical nutrition therapy is delivered according to nutrition practice guidelines, positive health outcomes result. They outline specific clinical outcomes as well as therapeutic lifestyle changes for individuals with type I and type 2 diabetes and gestational diabetes mellitus. They also recommend frequency and length of contact as well as time between encounters. All members of the healthcare team, not limited to the registered dietitian, should be involved in diabetes treatment and management to be able to apply the principles of medical nutrition therapy and use the same core set of behaviors to measure outcomes.

Evaluation of eating behavior may be done by patient self-report through standard assessment questions (e.g., 24-hour recall and food frequency questionnaire), review of blood glucose and food records, and skill checks by the educator (using labels, restaurant menus, food models, etc.). An individual's type of food choices (including alcohol), the amount of food (or a particular nutrient such as carbohydrate) eaten, the timing of meals, and the effect of food on blood glucose should be measured at baseline and about two to four weeks later, and then about every three to six months. Assessment of the participant's knowledge of anticipatory behavior is also important, such as how to apply the meal plan in special situations (e.g., sick days, traveling, schedule changes, and dining out), and how to use eating behavior for compensatory situations (e.g., problem solving for changes in a routine, preventing low blood sugar, and balancing exercise and food). Problem-solving behavior is assessed using such methods as role playing and discussing a variety of real-life scenarios.

It will be evident to persons skilled in the art that eating behavior outcomes are also relevant to self-management education for other chronic diseases. For chronic heart disease, for example, knowledge and control of saturated fat and sodium intake are important.

The third self-care behavior important to diabetes self-management education, as well as self-management education for many other chronic diseases, is medication taking. Medication-taking behavior combines cognitive and technical skills associated with taking oral, topical, and/or injected medications. Appropriate medication-taking behaviors include administration at recommended time(s) of day and dose frequency; correct dose preparation, selection, or calculation; administration technique and skills; and consistency over time. Cognitive and decision-making behaviors concerning medication taking include adjustment for delayed or missed doses, management or recognition of adverse effects, and recognition of drug failure (lack of efficacy) by interpreting symptoms or the results of self monitored clinical tests such as blood glucose or blood pressure.

Medications are important in the management of many chronic diseases. Medications are important to diabetes health outcomes for at least three major reasons. First, pharmacotherapy is either imperative or eventually needed to achieve desired glucose treatment goals for most individuals with diabetes. In type 1 diabetes, drug therapy is imperative to sustain life as well as to attain glycemic control. In type 2 diabetes, the progression of pathophysiologic defects (insulin resistance and relative or absolute insulin secretory deficiency) eventually necessitates the addition of medication(s) to the diabetes management plan. In gestational diabetes, the need for medication during the course of pregnancy is not predictable. In all instances, pharmacotherapy is intended to augment nonpharmacologic (lifestyle) interventions.

Second, medical nutrition therapy and physical activity, although important, are difficult to sustain or may be insufficient to manage blood glucose levels. Aggressive (intensive) pharmacotherapy in combination with lifestyle interventions has been shown to lower blood glucose levels and result in clinical benefits, including reduced risk for diabetes complications.

Third, medication-taking behaviors are particularly important to diabetes health outcomes. Not taking prescribed medications or taking them incorrectly can interfere with achieving the expected or desired outcome.

The primary goal of the medication-taking outcome of diabetes self-management education is an assessment of, and improvement in, medication knowledge, adherence, and skills. This outcome does not focus on whether the optimal medication or dose has been prescribed, although the two are intertwined. Medication efficacy cannot be clinically assessed if a medication is not being taken consistently and as prescribed (e.g., increasing the dose of a drug that is not being taken is unlikely to improve efficacy). Similarly, the correct drug regimen is likely to fail if it is not being administered correctly, consistently, and as prescribed.

Assessment of medication-taking behaviors can be a component of the initial patient evaluation. Disparities between the prescribed and actual medication-taking behaviors generally should be noted and addressed with the patient, with goals being collaboratively established.

Ongoing assessment should be performed at least annually, or at intervals deemed appropriate to reinforce or confirm the appropriate behaviors. The educator should recommend appropriate medication delivery systems (e.g., pens, pumps, and accessory items), drug regimen aids (e.g., drug calendars, daily pill boxes, and pill splitters), or innovative techniques specific to the patient to optimize medication-taking behaviors before problems arise.

Behavioral changes or outcomes generally expected from self-management education for medication taking include acquisition of or improvement in knowledge to assure competent, confident, and safe drug use. For example, patients and caregivers want to be confident and competent in recognizing side effects or drug toxicity, and be prepared to take corrective or preventive actions. These actions may be as simple as being able to report a drug regimen to a rescue squad or as complex as making insulin adjustments based upon a prescribed supplemental, retroactive, or prospective algorithm.

Comparing the patient's self-monitoring records (manually recorded or by meter memory printouts) with the dietary, exercise, and medication log is a useful way to assess the patient's application of the medication dosing scheme as well as the appropriateness of an algorithm or treatment plan. Other important changes or outcomes may require a specific level of skill in the technical aspects of medication administration, coupled with consistency of medication administration. For many such skills, a good assessment tool is observing the patient or caregiver perform the procedures. For other skills, the use of role-playing or “what if” scenarios may best reveal the patient or caregiver's ability to respond to unusual or adverse situations requiring administration, manipulation, or omission of a medication.

Another aspect of medication-taking behavior is the consistency with which a medication is taken and how well the patient administration pattern matches the prescribed pattern. Reviewing patient self-report diaries, measuring the amount of drug used or unused (e.g., pill counting), or checking refill profiles may all be helpful in determining the percentage of medication taken as well as the consistency and timing of doses per day. Medication nonadherence is understandably difficult for patients to acknowledge. Therefore, the educator may have good collaboration skills to work with patients in identifying and resolving barriers to optimal medication-taking behaviors.

The fourth self-care behavior important to diabetes self-management education is monitoring of blood glucose. For self-management education of other chronic disease, another self-monitored clinical parameter, sign, or symptom may be appropriate.

Monitoring of blood glucose requires a combination of technical skills and cognitive skills, including the ability to interpret results that allow patients and their healthcare teams to evaluate individual responses to therapy to assess if glycemic targets are being achieved.

Monitoring of blood glucose has been shown to reduce acute complications of diabetes, such as diabetic ketoacidosis and severe hypoglycemia. Self-monitoring makes patients feel less dependent on professionals. It requires them to become involved in self-management of their diabetes and connects them to the outcomes of their measurement activities-their own blood glucose levels.

Diabetes self-management education can include teaching accurate and reliable skills for self-monitoring of blood glucose, proper interpretation of results, and how to use results to adjust medical nutrition therapy, exercise, or pharmacological therapy to achieve specific glycemic goals. The optimum frequency goal for self-monitoring of blood glucose for type 1 diabetes is three or more times daily. It is important for individuals with diabetes to establish their own personal glycemic goals, which may or may not be consistent with optimum monitoring of blood glucose that results in the greatest metabolic benefit. Educators should make efforts to increase the individual's understanding of glycemic goals for appropriate use of self-monitored blood glucose results. Identifying and resolving blood glucose monitoring barriers are also important for achieving optimum self-monitoring blood glucose behavioral goals. Self-monitoring of blood glucose is especially important for individuals taking insulin or sulfonylureas to monitor for and prevent asymptomatic hypoglycemia. Frequency and timing of glucose monitoring should be dictated by the needs and goals of the individual patient to facilitate achieving his or her individualized glucose goals.

Baseline assessment of blood glucose monitoring behavior may include method and technique, frequency and schedule of monitoring, and number of recommended blood glucose checks not done. Individual monitoring behavior may be reassessed within about two to four weeks and about every three to six months thereafter. The individual's goal for desired change also should be assessed, as well as barriers to change including cost, inadequate understanding about health benefits and proper use of results, psychological and physical discomfort, time requirements, physical setting, and complexity of the monitoring procedure. Data can be collected through self-report methods including records or logs, and may be supported by data management glucose meters.

The fifth self-care behavior for diabetes self-management education is problem solving, especially for high or low blood glucose levels and sick days. For other chronic diseases, other problems will be evident to persons skilled in the art that require solving outside the healthcare setting by affected patients.

Problem solving is a learned behavior that includes generating a set of potential strategies for problem resolution, selecting the most appropriate strategy, applying the strategy, and evaluating the effectiveness of the strategy. Problem solving is an essential skill for effectively self-managing diabetes and involves more than knowledge or skill acquisition. As a behavior to be tracked and measured by diabetes education programs, the primary focus is on the diabetes problem-solving behavior of recognizing and responding to unanticipated situations of hypoglycemia, hyperglycemia, and sick days.

Problem-solving measures have been shown to be effective predictors of dietary, exercise, and medication self-care. For managing fluctuations in blood glucose levels, individuals must often make decisions about food, activity, and medication adjustment. Individuals with chronic disease typically progress from total reliance on a prescribed regimen to making modifications that are tailored to unique lifestyle needs and that continue to evolve over time. It may take as long as 15 years for some individuals to encounter all common problems associated with having diabetes. People move from a novice to an expert role in their own self-management in no specific time frame; but they can progress along the continuum with effective support of their critical thinking skills. Recent research suggests that excessively high or low blood glucose levels may influence problem-solving skills, yet at those times the individuals with diabetes or their support persons must respond appropriately to avoid serious consequences. Researchers have indicated that problem-solving skills are critical for helping individuals manage chronic illness treatment regimens.

Immediate educational goals include individually defined blood glucose levels, physical signs and symptoms, and appropriate treatment for high and low blood glucose levels and sick days, which together comprise the foundation for living with diabetes. Behavioral goals focus on developing appropriate problem-solving skills for responding to each blood glucose reading and for sick days. These goals progress from immediate safety issues to improving overall glycemic control and well-being as the individual becomes more accomplished with the self-management of the disease. Applying problem-solving activities to all of the diabetes self-care behaviors is an effective way to prevent, detect, and treat acute fluctuations in glucose control and acute complications.

Educators may work collaboratively with participants in self-management education programs by using situational problem solving to develop strategies to anticipate and overcome carriers to effective disease self-care. Situational problem solving focuses on real life scenarios rather than on comprehensive case studies (e.g., “my husband eats ice cream in front of me” or “I have to carpool my kids to soccer from 5 to 7 p.m., four days a week”). Actively involving participants in identifying strategies and solutions acknowledges that they are experts on their own problems and provides support for solving the problems. Diabetic patients who are treated with medications must be educated on hypoglycemia recognition, prevention, and treatment. All participants and/or support persons should be made aware of sick-day self-management and when to access the healthcare system.

Proactive problem resolution may be more straightforward for acute complications than for more complex issues such as when to follow up with the healthcare provider for an adjustment in treatment or the introduction of more complex treatment regimens. In addition, not all patient participants desire to be the primary decision makers for their self-care, so more active caregiver or educator participation in the problem-solving process may be appropriate. Education programs may place special emphasis on identifying and helping individuals with low levels of problem-solving skills to improve their health outcomes.

The detailed reasoning involved in decision making is difficult to assess apart from experience. Assessment tools that measure the participant's intent to respond to proposed situations and observational measures are helpful in the educator's assessment. Problem solving scenarios provide a measure of behavioral intent but not the actual behavior. Participant self-report about problem management with blood glucose monitoring data may provide objective information regarding the use of food, activity, medication, or ketone testing for resolving problems. Reviewing a log book or meter memory may provide data regarding treatment of high or low blood glucose levels. Medical charts and patient self report for hospital admissions or emergency room visits for hyperglycemic and hypoglycemic events can reveal the frequency or seriousness of those episodes. Other health status measures such as patient self-report of days missed from work, school, or other activities due to diabetes-related issues, especially for out-of-control blood glucose, can be tracked and may provide an indication of problem-solving ability. The educator generally should also try to understand the financial, cognitive, emotional, and physical barriers that prevent optimal problem solving in some situations.

The sixth self-care behavior for the example of diabetes self-management education is reducing risks of diabetes complications. Reducing risk-factor behaviors for diabetes self-management involves understanding, seeking, and maintaining several preventive healthcare services on a periodic basis, such as eye examinations, routine medical follow-up, and dental examinations. In addition, other self-initiated activities such as foot inspection, appropriate aspirin use, and smoking cessation are important behaviors that should receive emphasis during the educational process. Barriers to risk-reduction behavior are primarily related to financial constraints, mobility, lack of awareness, perceptions of susceptibility to complications, and especially social-environmental influences. Reducing these barriers through educational strategies and interactive instruction helps to increase self-promoted risk-reduction behaviors.

The initial step in chronic disease self-management education as it relates to risk reduction activities may be to inform the affected individual about the various preventive care services that can reduce complications. Once these activities are understood, providing a schedule of the frequency of performing these activities gives the individual a self-directed goal and an expectation about his or her health care team. Once these behavioral goals are initially accomplished, their long-term maintenance should be reinforced as a way of reducing complications from the disease.

The recommended preventive healthcare services for diabetes are well documented. When the patient, educator, and healthcare provider work as a team to follow these scheduled services, self-management behavior is improved and maintained. Empowered individuals with self-directed goals can perform many of these activities at home, including foot exams, appropriate aspirin utilization, and reducing or quitting smoking. Successfully increasing risk-reduction behaviors in individuals with diabetes is achieved through identifying the behaviors, interactively discussing how these behaviors reduce specific complications, and helping individuals to develop a maintenance schedule that can be monitored by themselves, the educator, and the healthcare provider.

Short-term collection of outcomes related to risk-reduction behaviors can be achieved through self-report via oral communication, questionnaires, or written maintenance schedules. Data collected through self-report methods may be validated by having individuals demonstrate these activities, and further validated by laboratory or claims data from healthcare organizations.

The seventh self-care behavior for self-management education is living with the disease, i.e., psychosocial adaptation to the disease. Psychosocial adaptation may include all aspects of living with a chronic disease: what people do to cope with their disease, how they perceive their situation, and how they relate to others involved in their lives.

Psychosocial factors are outcomes. Quality of life, a subjective measure, is arguably the ultimate outcome, and health status is important because it affects quality of life. Psychosocial factors also are important because they can affect health outcomes both directly (through psychophysiologic pathways) and indirectly (through behavioral pathways). Numerous studies have suggested that psychosocial distress has direct, psychophysiologic effects on health. Research indicates that these linkages remain even when controlling for the levels of risk factors that may be influenced by psychological distress (e.g., diet and exercise). Psychosocial factors also affect health indirectly by influencing other self-care behaviors. In addition to the effects of coping and distress, self care behavior is a function of a person's behavioral intentions, motivations, and ability to resolve barriers to self-care. Individuals who are not motivated to engage in effective self care will not make the necessary commitment to do so, and even the best of intentions will prove fruitless if the individual cannot figure out how to overcome barriers to following through on his or her intentions. Improving the quality of life requires patients to balance clinical goals with psychological well-being, deal with their emotional distress, and manage their relationships with others.

Education may involve more than simply giving information and teaching self-care skills. Effective self-management education helps individuals to be motivated to change their behavior; have specific, achievable behavioral goals; and overcome barriers (e.g., environmental, social, and psychological) to implementation. Educators can help elicit and reinforce individuals' motivation to make behavior change, including discussing the benefits of changing their behavior. However, motivation is an internal function of the individual. Educators are most successful when they work with patients' issues rather than substitute their own goals for those of the patient. Educators should work with individual participants to collaboratively define specific goals for behavior change and help them build self-efficacy. Goals should be established that are consistent with the participants' unique circumstances, that the participants feel comfortable with, and that do not require an unrealistic burden or sacrifice. Educators also should collaborate with individuals in a problem-solving process to help find ways to overcome barriers to behavior change. Many persons may not be able to achieve the goals they set for themselves. Educators should help them identify strategies to actually change what they do, not simply give medical advice about what they should do. Some patients may be so debilitated by psychological distress or illness that referral for medication or mental health counseling is required before the educator can work effectively with them on behavioral counseling.

When working with patients, the educator may consider potential impacts on quality of life, such as the psychological costs to the individual of a course of action. The educator should think through such issues with each patient so that alternative courses of action with lower psychological costs can be considered. When individuals have problems related to their disease that cause distress and problem solving cannot alleviate these problems, the educator should help them identify ways of coping with the problems. Often, individual participants will have effective coping techniques that they can employ; sometimes new coping techniques may need to be devised. Sometimes the problems to be dealt with involve other people in the patients' lives. When this occurs, the educator can help the patients develop strategies for dealing with these other people. Sometimes bringing these others into a collaborative process with the individual and educator is helpful.

Psychosocial factors are quite diverse. Psychological distress, especially depression, is quite common among persons with chronic disease and should be assessed. Numerous brief screening questionnaires are available that a participant can complete independently and that can be scored quickly. A diabetes-specific measure of distress is also available. Diagnostic interviews permit diagnosis of psychological disorders but generally are more elaborate and require training in their administration.

Quality of life can also be measured by a variety of paper-and-pencil questionnaires. Several investigators have developed diabetes-specific measures of quality of life. Understanding factors that are measured by these instruments (e.g., functional limitations, disease burden, and satisfaction with treatment) can be useful in formulating behavior change plans and assessing the impact that changes have on individuals' lives.

Peoples' psychological adjustment and success in dealing with the challenges of living with a chronic disease are strongly influenced by their coping skills and the social support they receive from others. Coping skill measures can be generic or disease specific. Social support measures also may be generic or disease specific.

Another psychosocial dimension is health-related beliefs and perceptions related to behavior change (e.g., treatment self-efficacy, readiness/intention to change, and barriers to treatment). These factors are domain specific to a significant degree. Individuals may be interested in changing one behavior but not others; barriers may inhibit change in one behavior but not another. Measuring these factors as they relate to specific self-care behaviors represents an important step in identifying targets for educational interventions and assessing outcomes. A measurement instrument that captures many of these dimensions for diabetes is the Diabetes Self-Management Assessment Report Tool (D-SMART™), hereby incorporated herein.

To facilitate use of the present method, any measurements or other data collected on a patient may be collected, stored, or analyzed using a computer. Data from multiple patients may be aggregated into a computerized database. A computer software program could be used to prompt and assist the educator with measurements to assess and collect data. A computer software program could also be used to provide instructions to a patient. The term “computer software program” or “software module” or “computer-implemented method” referenced in this disclosure is meant to broadly cover various types of software code in combination with hardware to run the software including but not limited to routines, functions, objects, libraries, classes, members, packages, procedures, methods, or lines of code together performing similar functionality to these types of coding. The components of the present disclosure are described herein in terms of functional block components, flow charts and various processing steps. As such, it should be appreciated that such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, SQL, C++, Java, COBOL, assembler, PERL, or the like, with the various algorithms being implemented with any combination of data structures, objects, processes, routines or other programming elements. Further, it should be noted that the present invention may employ any number of conventional techniques for data transmission, signaling, data processing, network control, and the like.

Application of the seven core outcomes/performance measures to evaluate effectiveness provides the educator and the clinician with the ability to understand what is working and what is not working. Over time, as this method is adopted and followed, a core of knowledge about specific patient-focused interventions will emerge. The clear understanding and adoption of standards and core measures for self-management education outcome measurement that this inventive system provides will permit progression of education to a level of maturity that will establish it as an essential therapeutic intervention in the care of people with diabetes and other chronic diseases.

### EXAMPLE

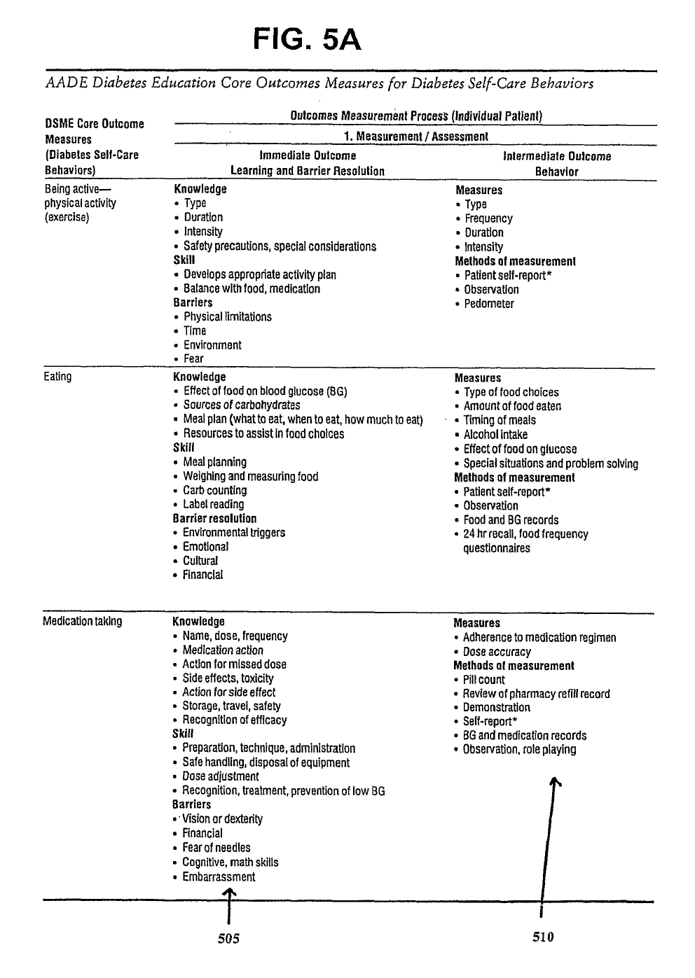

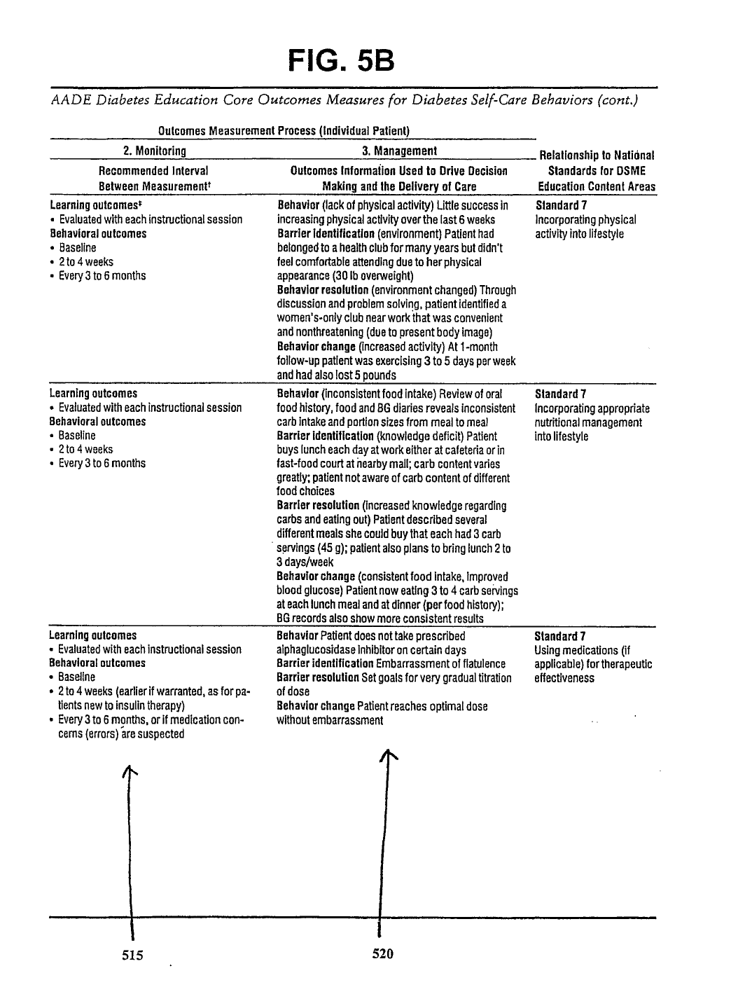

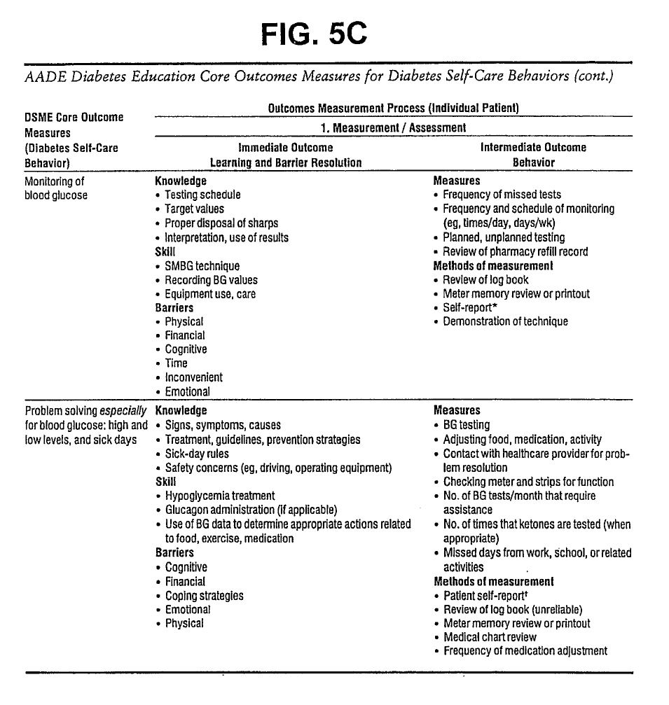

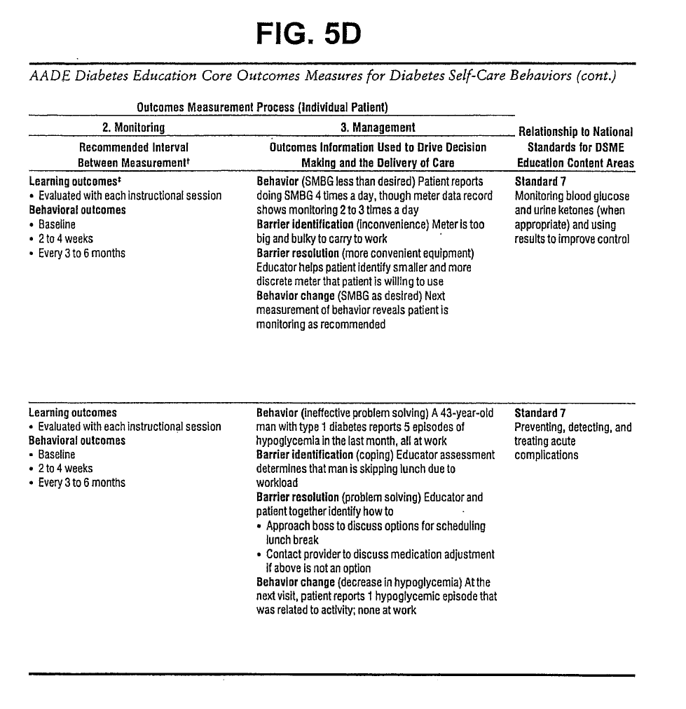

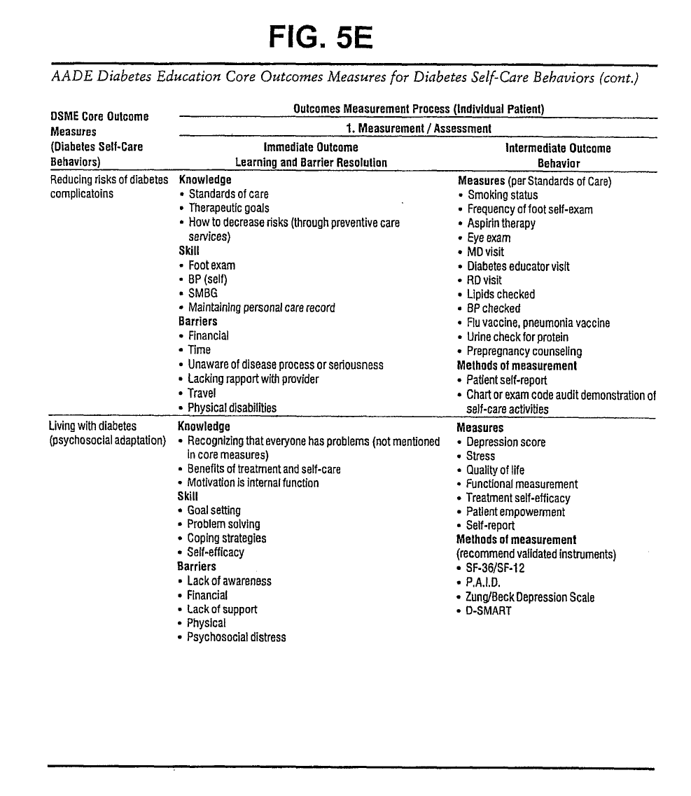

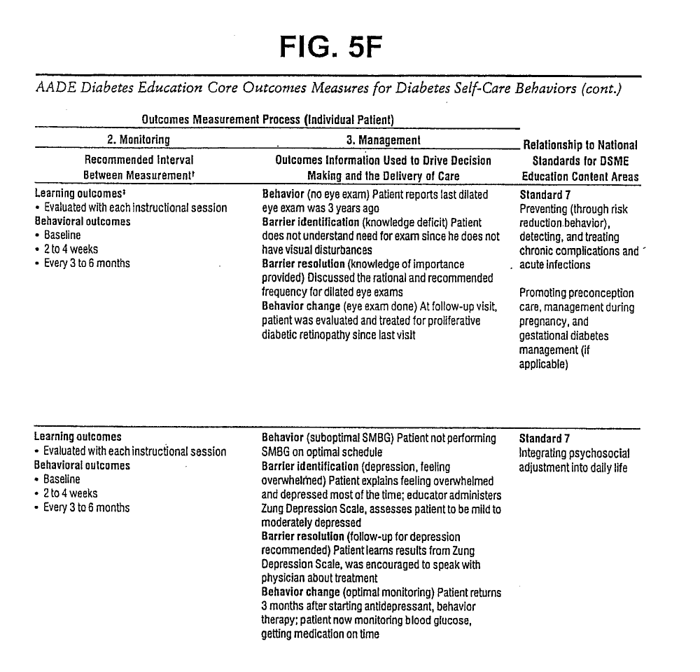

FIGS. 5A-5F illustrate application of an aspect of the method according to an embodiment of the present disclosure for use with diabetes self-management education. The figures outline how the system could be used to determine and improve the effectiveness of self management education for a participating individual with diabetes mellitus. FIG. 5A and FIG. 5B illustrate an outline for evaluation of three self-care behaviors: being active, eating, and medication taking. FIG. 5C and FIG. 5D illustrate an outline for evaluation of two other self-care behaviors: monitoring of blood glucose and problem solving. FIG. 5E and FIG. 5F illustrate an outline for evaluation of two further self-care behaviors: reducing risks of complications and psychosocial adaptation.

In FIGS. 5A and 5B, the outcomes measurement process for an individual patient is outlined in columns 505, 510, 515, and 520. The entries in column 505 in FIG. 5A illustrate identification of knowledge, skills, and barriers to be addressed by the educator with the participant to help the participant learn about the self-care behavior, acquire skills relating to the behavior, and resolve barriers preventing appropriate behavior. Each self-care behavior has a separate and specific list of knowledge, skills, and barriers. In this example, the knowledge associated with being active comprises type, duration, intensity, safety precautions and special considerations. The skills associated with eating comprise meal planning, weighing and measuring food, carbohydrate counting, and label reading. The barriers to medication taking include vision or dexterity, financial, fear of needles, cognitive or math skills, and embarrassment.

In column 510 of FIG. 5A, the measures and methods of measurement for each self-care behavior for this patient are listed, illustrating assessment of intermediate outcomes. In this example, measures for the behavior of eating comprise type of food choices, amount of food eaten, timing of meals, alcohol intake, effect of food on glucose, special situations and problem solving. Methods of measurement in this example for medication taking include pill count, review of pharmacy refill record, demonstration, self-report, blood glucose and medication records, observation, and role playing.

In FIG. 5B, column 515 lists recommended intervals between measurements for each outcome and each self-care behavior as proposed by the educator for this patient in this example. In this example, learning outcomes are evaluated with each instructional session and behavioral outcomes are measured at baseline, at two to four weeks, and every three to six months. For medication taking behavior, the illustration notes that behavioral outcomes may be measured earlier or more often if the patient's situation warrants it.

In column 520 of FIG. 5B, the educator has listed outcomes information to be used to drive decision making and the delivery of care in the management of the illustrative patient's education. In this example, for the behavior of being active, the educator has assessed the outcome of educational intervention for the patient and found “[1] little success in increasing physical activity over the last 6 weeks.” Working with the patient, the educator identified a barrier to the patient's physical activity: she didn't feel comfortable going to her health club because of her physical appearance. Through discussion and problem solving, the educator helped the patient to overcome the barrier and locate a nonthreatening health club. A behavior change of increased physical activity was noted at a one-month follow-up session with the patient.

Thus is shown how identifying specific behaviors to measure, identifying the knowledge and skills associated with the behavior and the barriers to change of the behavior, and measuring the continuum of outcomes of the behavior at specified intervals can determine and improve the effectiveness of education of patients having a chronic disease such as diabetes. It will be apparent to persons of ordinary skill in the art that variations and modifications may be made while remaining within the spirit and scope of the invention.

What is claimed is:

1. A method of improving a self-management education program for a patient having a chronic disease, the chronic disease being treatable through the patient's own behavior, the method comprising the steps of:
selecting at least one self-care behavior from a standardized set of behavioral outcomes related to the chronic disease;
measuring a baseline behavior for the patient for the selected at least one self-care behavior;
measuring the at least one self-care behavior at the end of an interval for the selected self-care behavior to gauge an extent of behavior change; and
adjusting the self-management education program where the extent of behavior change is negligible.

2. The method of claim 1, further comprising the standardized set of behavioral outcomes being one or more of being active, eating, taking medication, monitoring a measurable physiological characteristic, special problem solving for days when symptoms of the disease are extreme, reducing risks of complications related to the chronic disease, and adapting psychosocially.

3. The method of claim 1, further comprising the chronic disease being one or more of diabetes mellitus, chronic kidney failure, and chronic heart disease.

4. The method of claim 1, further comprising the step of measuring the at least one self-care behavior comprise the steps of:
observing the at least one behavior;
identifying a barrier; and
providing a behavior resolution to overcome the barrier;

5. The method of claim 4, further comprising tying the at least one behavior to a national standard for the chronic disease.

6. The method of claim 1, further comprising the chronic disease being diabetes mellitus.

7. The method of claim 6, further comprising the standardized set of behavioral outcomes being one or more of being active, eating, medication taking, monitoring blood glucose, special problem solving for days when blood glucose levels are at an extreme of an acceptable range, reducing risks of diabetes complications, and adapting psychosocially.

8. The method of claim 7, further comprising the step of measuring the at least one self-care behavior being at least one of patient self-reporting and observing the patient.

9. The method of claim 7, further comprising the interval being about 2 to 4 weeks.

10. The method of claim 7, further comprising the interval being about 3 to 6 months.

11. The method of claim 7, further comprising the at least one self-care behavior being active, and further comprising educating the patient on one or more of knowledge aspects of being active, skill aspects of being active, and barrier aspects of being active, the knowledge aspects including one or more of a type, a duration, an intensity, and a safety precaution, the skill aspects including one or more of developing an appropriate activity plan and balancing the activity plan with food and medication, and the barrier aspects including one or more of physical limitations, time, environment, and fear.

12. The method of claim 7, further comprising the at least one self-care behavior being eating, and further comprising educating the patient on one or more of knowledge aspects of eating, skill aspects of eating, and barrier aspects of eating, the knowledge aspects including one or more of effects of food on blood glucose, sources of carbohydrates, meal plans, and resources to assist in food choices, the skill aspects including one or more of meal planning, weighing food, carbohydrate counting, and label reading, and the barrier aspects including one or more of environmental triggers, emotional barriers, cultural barriers, and financial barriers.

13. The method of claim 12, further comprising the step of measuring the at least one self-care behavior being at least one of patient self-reporting, observing the patient, reviewing food and blood glucose records, and completing 24 hour food frequency questionnaires.

14. The method of claim 7, further comprising the at least one self-care behavior being medication taking, and further comprising educating the patent on one or more of knowledge aspects of medication taking, skills aspects of medication taking, and barrier aspects of medication taking, the knowledge aspects including one or more of knowing a medication name, a medication dose, a medication frequency, a medication action, an action to take when a medication dose is missed, a side effect, a medication toxicity, an action for a medication side effect, proper medication storage, proper medication travel storage, and a medication efficacy, the skills aspects including one or more of techniques for administering medication, and adjusting a dose of medication, and safe handling of a medication, the barrier aspects including one or more of vision, dexterity, a financial barrier, a fear of needles, cognitive math skills, and embarrassment.

15. The method of claim 14, further comprising the step of measuring the at least one self-care behavior being at least one of counting pills, reviewing a pharmacy refill record, self-reporting, reviewing blood glucose and medication records, and observing the patient.

16. The method of claim 7, further comprising the at least one self-care behavior being monitoring blood glucose, and further comprising educating the patent on one or more of knowledge aspects of monitoring blood glucose, skills aspects of monitoring blood glucose, and barrier aspects of monitoring blood glucose, the knowledge aspects including one or more of developing a testing schedule, targeting blood glucose values, disposing of sharps, and interpreting blood glucose levels, the skills aspects including one or more of self monitoring of blood glucose (SMBG) techniques, recording blood glucose values, and using blood glucose monitoring equipment, the barrier aspects including one or more of a physical barrier, a financial barrier, a cognitive barrier, a time barrier, an inconvenience barrier, and an emotional barrier.

17. The method of claim 16, further comprising the step of measuring the at least one self-care behavior being at least one of reviewing a log book, self-reporting, and demonstrating a technique.

18. The method of claim 1, further comprising:
aggregating measured baseline behaviors for a plurality of patients;
aggregating measured self-care behaviors for a plurality of patients to gauge the extent of behavioral change attributable to the plurality of patients;
adjusting the self-care management program when the extent of behavioral change attributable to the plurality of patients is negligible.

19. A computer-implemented method for assessing and improving a self-management education program for a patient having a chronic disease, the chronic disease being treatable through the patient's own behavior, comprising:
providing an interface for selecting at least one self-care behavior from a standardized set of behavioral outcomes related to the chronic disease;
inputting a measured a baseline behavior for the patient for the selected at least one self-care behavior;
inputting a measured at least one self-care behavior measured at the end of an interval for the selected self-care behavior;
displaying a report on an extent of behavior change; and
adjusting the self-management education program where the extent of behavior change is negligible.

20. A method of improving a self-management education program for a patient having a diabetes, the chronic disease being treatable through the patient's own behavior, the method comprising the steps of:
assigning behavior change as a key outcome measurement for the self-management education program;
selecting a plurality of self-care measures to determine the effectiveness of the self-management education program;
evaluating the plurality of the self-care measures at a baseline and after a regular interval after educating the patient;
assessing a continuum of outcomes to demonstrate an interrelationship between educating the patient and behavior change; and
using individual outcomes to guide intervention and improve care for the patient.

21. The method of claim 20, further comprising collecting a plurality of individual patient outcomes to form an aggregate of population outcomes and using the aggregate to guide programmatic services and to continually improve quality of the self-management education program.
